(19) United States
(12) Patent Application Publication
(10) Pub. No.: US 2010/0305981 A1
(43) Pub. Date: Dec. 2, 2010

(54) SYSTEM AND METHOD OF PROVIDING VOUCHER DATA

(76) Inventors: Kevin Edward Masami Shin, Honolulu, HI (US); Thomas S. Blankley, JR., Princeville, HI (US); Taeho Yum, Honolulu, HI (US)

Correspondence Address: FISH & RICHARDSON P.C., P.O BOX 1022, Minneapolis, MN, 55440-1022, US

(21) Appl. No.: 12/475,270

(22) Filed: May 29, 2009

(51) Int. Cl. G06Q 30/00; G06F 17/30; G06Q 50/00

(52) U.S. Cl. 705/5; 705/26

(57) ABSTRACT

Methods and systems for providing voucher data for a booked activity are provided. One provided embodiment includes receiving a first request at a server, the first request including a first facility identifier and having been generated using a first device that is located at a facility corresponding to the first facility identifier, which facility is remote from the server, and selecting a first set of data from a database based on the first facility identifier. A first response is generated based on the first set of data and the first request, and the first response is transmitted to the first device. A first purchase confirmation is received at the server, the purchase confirmation being generated based on the first response received at the first device, and first voucher data is provided based on the first purchase confirmation.

### TECHNICAL FIELD

This invention relates to systems and methods of providing entertainment vouchers, and more particularly to systems and methods of providing entertainment vouchers through an in-room entertainment system.

### SUMMARY

Systems and methods for providing voucher data for a booked activity are provided. In one provided embodiment a first request is received at a server and a first set of data is obtained from a database based on the first facility identifier. The first request includes a first facility identifier and is generated using a first device that is located at a facility corresponding to the first facility identifier. The facility is remote from the server. A first response is generated based on the first set of data and the first request, and the first response is transmitted to the first device. A first purchase confirmation is received at the server, the purchase confirmation being generated based on the first response received at the first device, and first voucher data is provided based on the first purchase confirmation.

In some embodiments, the facility identifier includes a uniform resource locator (URL) associated with the facility.

In some embodiments, the method further includes transmitting price code information to the first device, and receiving guest number information from the first device, the guest number information corresponding to the price code information, the first purchase confirmation being generated based on the guest number information and the price code information.

In some embodiments, the method further includes receiving a second request at the server, the second request having been generated using a second device and including the first facility identifier, generating a second response based on the first set of data and the second request, transmitting the second response to the second device, receiving a second purchase confirmation at the server, the second purchase confirmation being generated based on the second response received at the second device, and providing second voucher data based on the second purchase confirmation.

In some embodiments, the method further includes receiving a second request at the server, the second request having been generated using a second device and including a second facility identifier associated with a second facility, at which the second device is located, selecting a second set of data from the database based on the second facility identifier, the second set of data being different than the first set of data, generating a second response based on the second set of data and the second request, transmitting the second response to the second device, receiving a second purchase confirmation at the server, the second purchase confirmation being generated based on the second response received at the second device, and providing second voucher data based on the second purchase confirmation.

In some embodiments, the method further includes providing a local database that is remotely located from the database, and presenting data from the local database at the first device, the first request being generated based on the data. The data from the local database can correspond to activities that are available for reservation through the first facility, and the first set of data from the database can include at least one of availability information and pricing information for the activities

In some embodiments, the first request includes information indicating an activity and a number of people to participate in the activity.

A computer-readable storage medium encoded with a computer program comprising instructions that, when executed, operate to cause one or more processors to perform operations in accordance with the methods described herein is also provided.

A system including one or more processors, and a computer-readable storage medium coupled to the one or more processors having instructions stored thereon which, when executed by the one or more processors, causes the one or more processors to perform operations in accordance with the methods described herein is also provided.

### BRIEF DESCRIPTION OF DRAWINGS

FIG. 1 is a schematic illustration of an exemplar system architecture in accordance with the present disclosure.

FIG. 2 is a schematic illustration of a portion of the exemplar system architecture of FIG. 1 illustrated in further detail.

FIG. 3 is a schematic illustration of a portion of the exemplar system architecture of FIG. 2 illustrating exemplar software layers that can be implemented in accordance with the present disclosure.

FIG. 4 is a block diagram illustrating an exemplar software architecture in accordance with embodiments of the present disclosure.

FIGS. 5-10 illustrate exemplar screen-shots in accordance with embodiments of the present disclosure.

FIG. 11 is a flowchart illustrating exemplar steps that can be executed in accordance with embodiments of the present disclosure.

Like reference symbols in the various drawings indicate like elements.

### DETAILED DESCRIPTION

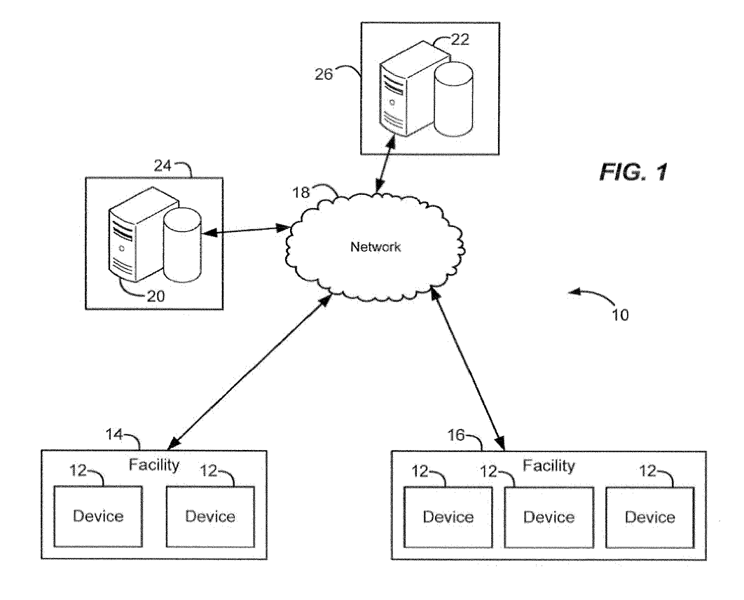

With reference to FIG. 1, an exemplar system architecture 10 is illustrated, and includes one or more devices 12 located at a facility 14, one or more devices 12 that are located at another facility 16, a network 18, a catalog server system 20, and a voucher server system 22. Catalog server system 20 is resident at a first location 24, and voucher server system 22 is located at a second location 26. Each device 12, catalog server system 20, and voucher server system 22 can communicate with one another through network 18. More specifically, data can be transferred between each device 12, and both catalog server system 20 and voucher server system 22.

In some embodiments, first location 24 may be remote from facilities 14 and 16 as illustrated in FIG. 1. In such embodiments, first location 24 is part of another facility (not shown). In some embodiments, first location 24 may be part of either facility 14, or facility 16. In such embodiments, catalog server system 20 is resident at either facility 14, or facility 16. Second location 26 is part of another facility (not shown) that is remote from facilities 14, 16. This other facility can include a third-party vendor facility that hosts the voucher server system 22, such that catalog server system 20 is remote from voucher server system 22. As used herein, the term ‘remote’ indicates a geographical separation between two things.

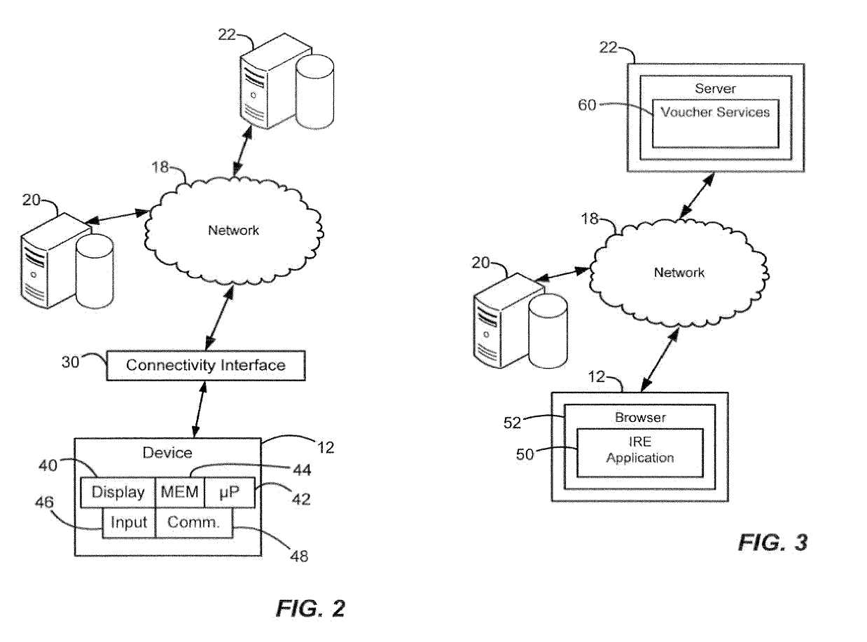

Referring now to FIG. 2, an exemplar device 12 is depicted which can include any number of devices, for example, and can communicate with catalog server system 20 and voucher server system 22 through a connectivity interface 30 and network 18. Each device 12 typically includes a display 40, a processor 42, memory 44, an input interface 46, and a communication interface 48. Processor 42 can process instructions, which can include, for example, instructions stored in memory 44 to display graphical information on display 40, instructions to send and/or retrieve data from catalog server system 20, and instructions to send and/or retrieve data from voucher server system 22. Displays 40 may be any of a variety of visual displays such as, for example, a liquid crystal display (LCD), an organic light emitting diode (OLED) display or, where high intensity is desired, a plasma display. In some implementations, memory 44 can include volatile, and/or a non-volatile memory. Each device 12 may also, in some embodiments, include a computer-integrated television.

Input interface 46 provides the ability to input information to device 12 and may be implemented in any of a variety of manners known in the art such as, for example, a keyboard, a touchscreen, a mouse, a trackball, a microphone, a touchpad, a remote control and/or combinations thereof. In some implementations, an audio codec (not shown) can be provided, which receives audible input from a user or other source through a microphone, and converts the audible input to usable digital information. The audio codec can generate audible sound, such as through a speaker that is provided with device 12. Such sound may include, but is not limited to, sound from voice telephone calls, recorded sound (e.g., voice messages, music files, etc.), and sound generated by applications operating on device 12.

Exemplar depicted device 12 communicates with network 18 through connectivity interface 14. Connectivity interface 14 can include, but is not limited to, a Wi-Fi system (e.g., 802.x), a cable modem, and/or a DSL/dial-up interface, and enables data to be transmitted through network 18. Network 18 can be provided as any of a variety of networks including, for example, a local area network (LAN), a wide area network (WAN), a wireless LAN (WLAN), a metropolitan area network (MAN), a personal area network (PAN), the Internet, an optical net and/or combinations thereof.

Referring again to FIG. 1, facilities 14 and 16 may be a hotel, a resort, or any other establishment that offers lodging to guests. In such contexts, device 12 is located within a room of the facility, such as, for example, a hotel room. From there, a user (e.g., a hotel guest) can access an activity catalog using device 12, and book an activity or activities in accordance with the present disclosure. As discussed in further detail below, device 12 communicates with catalog server system 20 and voucher server system 22 via network 18. Catalog server system 20 provides data to device 12, which corresponds to one or more activities available for booking through the particular facility 14 or 16. Based upon information input by the user of device 12, voucher server system 22 provides data to device 12 which corresponds to the availability of particular activities. Voucher server system 22 further enables the user to book a particular activity or activities and provide payment information. Voucher server system 22 provides confirmation of the booked activity or activities and makes a voucher available to the user for each activity. The voucher is typically physical and can be made available in various manners. In some embodiments, voucher data can be electronically transferred to device 12 for local printing of a physical voucher by the user (e.g., in-room printing). In other embodiments, voucher data can be transferred to the facility for local printing of a physical voucher by facility staff. For example, a clerk, or concierge can receive the voucher data at a local device (e.g., a computer), and can print the voucher for pick-up by the user.

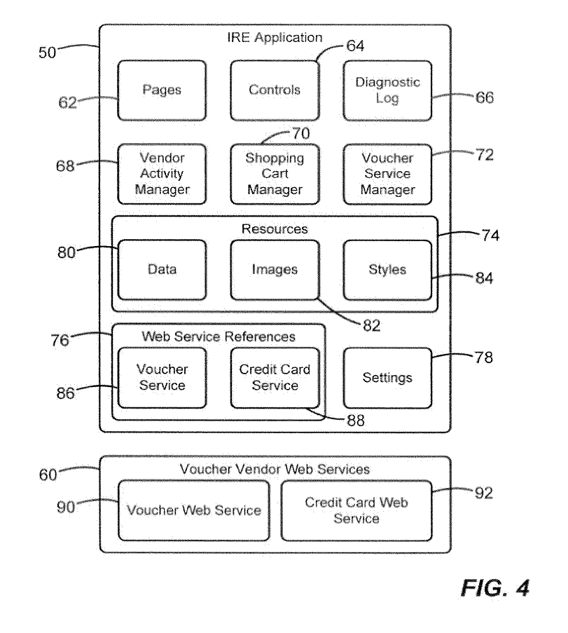

Referring now to FIGS. 3 and 4, an exemplar architecture will be described in detail. An in-room entertainment (IRE) application 50 functions as a portal to enable a user (e.g., a hotel guest) to browse and book activities. Exemplar activities can include, but are not limited to, attractions, tours, and/or restaurant reservations. Each of the activities is typically provided by an associated vendor, as discussed in further detail below. IRE application 50 is shown hosted within a browser 52 that can be deployed and accessed using device 12. IRE application 50 displays a plurality of activities that the user can browse and choose from to book. The inventory of available activities is maintained in catalog server system 20, which is selectively accessed based on a user request. More specifically, catalog server system 20 maintains a database of available activities, and provides information regarding the available activities to device 12 upon user request. The user can select one or more activities using device 12, and can indicate the number of persons participating in each. Based on the information input by the user, voucher server system 22 provides information regarding the availability of reservations for each activity. Once the user has selected all of the desired activities, billing information can be provided, the reservation(s) can be confirmed, and a voucher for the activity can be made available to the user.

In some embodiments, IRE application 50 can be provided as a compiled Windows Presentation Foundation (WPF) application that is hosted on secure voucher server system 22. The user can access IRE application 50 through device 12, which uses browser 52 to request IRE application 50 from voucher server system 22. The compiled IRE application 50 is loaded to device 12 through network 18, and executes within browser 52 on device 12. Consequently, IRE application 50 is much more responsive than a typical web-based application. IRE application 50 calls web services on voucher server system 22 to request activity inventory, process billing, and to book activities.

With particular reference to FIG. 4, exemplar IRE application 50 includes a plurality of components organized into specific component groups. IRE application 50 includes all of the components necessary to function with the exception of voucher vendor web services 60 that interface with IRE application 50. The components of IRE application 50 include pages 62, controls 64, diagnostic log 66, vendor activity manager 68, shopping cart manager 70, voucher service manager 72, a resources component group 74, a web service references component group 76, and settings 78. The components of resources component group 74 include data 80, images 82, and styles 84. The components of web services references group 76 include voucher service 86 and credit card service 88. The components of voucher vendor web services 60 includes voucher web service 90 and credit card web service 92.

Page component 62 can include WPF pages that provide the graphical user interface (GUI) for the user to interact with exemplar IRE application 50. The pages can use extensible application markup language (XAML) for the presentation layer, and can also include an associated code-behind file for business logic. The control component 64 can include WPF user control and classes. The user controls can also use XAML for the presentation layer with associated code-behind files. Vendor activity, shopping cart and voucher service manager components 68, 70, 72, respectively, abstract business logic and data from the presentation layer. Resources component group 74 includes the voucher and activity data, images and styles used by IRE application 50. Other resources can be included, such as, for example, videos. These resources can be compiled into IRE application 50, or can be referenced externally, either on device 12, catalog server system 20, voucher server system 22, or another location. The components of web service reference component group 76 provide a simple object model to access voucher vendor web services 60. Diagnostic log component 66 logs messages and/or errors.

Settings component 78 can be configured using a standard configuration file (e.g., .NET app.config file). In operation, IRE application 50 can be designed to load configuration information from the standard configuration file. Any changes made in the configuration file can take affect the next time IRE application 50 is loaded, which can occur when it is originally loaded to device 12, or refreshed in browser 52. The configuration file can provide a plurality of configuration sections that include, but are not limited to, service model configuration section (e.g., system.serviceModel) and an application configuration section (e.g., applicationSettings).

The service model configuration section contains configuration settings for voucher vendor web services 60 accessed by IRE application 50, and includes a service model bindings sub-section and a service model client sub-section. The service model bindings sub-section is located under a node (e.g., the configuration/system.service Model/bindings node) in the configuration file, and contains a plurality of configurable parameters for the vendor web services. The service model client sub-section is located under another node (e.g., the configuration/system.serviceModel/client node) in the configuration file, and includes endpoint uniform resource locators (URLs) for voucher vendor web services 60. The URL for an endpoint node can be modified to point to the a particular web service. Other attributes can specify the contract, name and binding of the web service. Exemplar web services, and their corresponding URLs include:
AtcoWebServiceSoap—https://voucher.atcosoftware.net/demo/blockbook/soap3.asmx
   AtcoPayPalSoap—http://voucherdev.atcosoftware.net/ccprocess/v1.0.service.asmx

The application configuration section includes configuration settings for several options available to IRE application 50. The configurable settings can include, but are not limited to, the following exemplar settings of Table 1:

TABLE 1
Exemplar Configuration Settings

| Setting Name | Description |
|---|---|
| FacilityID | The ID representing the client (e.g., device 12) that is using the |
| | system. This ID is passed to the catalog server system 20, and the |
| | vendor web services 60 of the voucher server system 22. |
| FacilityName | The name representing the device that is using the system. This |
| | name is passed to the vendor web service. |
| RoomID | The ID of the room the current instance of the application is |
| | running in. This ID is passed to the vendor web service. |
| BookingComments | General booking comments that will be passed to the vendor web |
| | services. |
| PromptForCreditCard | Indicates if the user will be prompted for a credit card when |
| | booking activities. |
| ValidCreditCards | A string array of credit card codes that the application will accept. |
| ValidCreditCardRegex_{ID} | A regular expression pattern for one of the credit card codes |
| | defined in “ValidCreditCards” where {ID} is the credit card code. |
| | The pattern is used to determine if a credit card number is valid |
| | for the specified credit card. |
| MerchantID | The merchant ID that is passed to the credit card web service 92. |
| VendorID | The vendor ID that is passed to the credit card web service 92. |
| LogLevel | Specifies what level of logging should be performed. Valid |
| | values are Debug, Information, Warning, and Error. |
| StaticVendorAID | For testing purposes, a vendor ID can be specified so that |
| | regardless of what a user selects, this vendor ID will be used. |
| StaticActivityAID | For testing purposes, a vendor activity ID can be specified so that |
| | regardless of what a user selects, this vendor activity ID will be |
| | used. |
| PerformLuhnCheck | Indicates if a Luhn check will be performed during credit card |
| | validation. |
| UseVendorActivity | Indicates if the vendor and activity XML data is a compiled |
| Resource | resource or if it is accessed via a URL. |
| VendorActivityDefinitionURL | The URL of the vendor and activity XML data, if any. |
| VendorActivityResourceName | The static resource name of the vendor and activity XML data, if |
| | any. |

In some embodiments, the RoomID setting is at a global level, such that it is the same for all devices 12 of a particular facility 14, 16 (e.g., all devices 12 of facility 14 include a common, first RoomID, and all devices 12 of facility 16 include a common, second RoomID that is different than the first RoomID). In other embodiments, the RoomID setting can be at a local level, such that it is different for each device 12 of any facility 14, 16. During normal operation (i.e., non-testing), the StaticVendorAID and the StaticActivityAID settings can be left blank.

Vendor and activity data is preferably managed in a single XML document. The XML document represents an XML serialized VendorActivityDefinition object. This enables the object to be portable and compatible with web services. This XML document can be compiled as a resource into IRE application 50, or can be accessed from a file on a web server depending on how it is configured. More specifically, the XML document can be provided by catalog server system 20 for presentation on device 12. The particular XML document that is provided by catalog server system 20 is based on the FacilityID. For example, facility 14 can have a first FacilityID that corresponds to a first XML document. Facility 16 can have a second FacilityID that corresponds to a second XML document, different from the first XML document.

Resources component group 74 includes data, images, and styles that are used to populate the XML document for a particular facility 14, 16. Exemplar images can include, but are not limited to, background images, a facility logo, vendor activity images, and/or a wait animation image. For example, the images can include images corresponding to activities that are available for booking through a particular vendor. In order to improve efficiency, each of the images can be compiled into IRE application 50. By way of non-limiting example, the background image, the facility logo, and wait animation images are referenced directly in the XAML styles and the can either be replaced by images with the same name, or can be renamed to use other images in the style XAML. The vendor's activity images are specified in the vendor activity data via data component 80. The specific image file name to uses is dictated by the vendor and activity data. Resources component group 74 can also include vendor video data for presentation to a user. Exemplar vendor video data can include activity trailers for advertising activities that are available for booking through the particular vendor.

IRE application 50 can change styles by changing an application file (e.g., App.xaml file) to reference an appropriate style dictionary file (e.g., StyleDictionary.xaml file) via styles component 84 of resources component group 74. Specific styles can be modified by changing the appropriate style dictionary file. In some embodiments, the style presented at one facility (e.g., facility 14) can be different than the style presented at another facility (e.g., facility 16). In this manner, the proprietor of each facility can present their own, unique style.

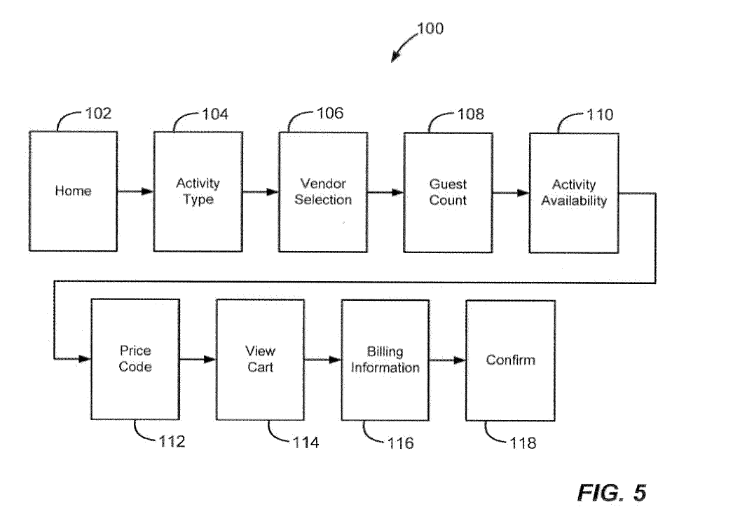

Referring now to FIGS. 5-10, the presentation of activity information in IRE application 50 is achieved using a series of pages (e.g., WPF pages). Each page is referenced in IRE application 50 similar to web pages, however, because they are based on WPF, extremely flexible presentation capabilities are provided in this depicted embodiment. In some embodiments, the pages each use XAML for the presentation markup and code-behind for any page specific business logic. Further, each page can inherit from a single class (e.g., MenuOSPage.cs), such that all pages have common functionality.

With particular reference to FIG. 5, an exemplar page flow 100 is illustrated. Exemplar page flow 100 includes a home page 102, an activity type page 104, a vendor selection page 106, a guest count page 108, an activity availability page 110, a price code page 112, a cart viewing page 114, a billing information page 116, and a confirmation page 118. As those of skill will appreciate, many varieties of page topics and content can be aggregated in particular embodiments and not all embodiments will employ such page strategies. Home page 102 is the initial landing page that the user is presented with on display 40 of device 12, and can be customized based on the particular facility 14, 16, at which the user is located. More specifically, when the user activates IRE application 50 using device 12, a call is sent to catalog server system 20 to retrieve the vendor and activity information that is available for booking through the particular facility 14, 16.

In some embodiments, the call can include a facility identification (e.g., FacilityID), which indicates the particular facility 14, 16 at which the user is located. Catalog server system 20 can retrieve specific vendor and activity information based on the facility identification, which is presented to the user on, for example, an activity type page 104. In this manner, only a sub-set of the vendors and/or activities available for booking are presented to the user, enabling the particular facility to tailor the options presented to the user. The sub-set of vendors and/or activities corresponds to those made available to the user by the particular facility 14, 16. For example, one facility may only choose to promote a sub-set of vendors and/or activities, as opposed to all available vendors and/or activities.

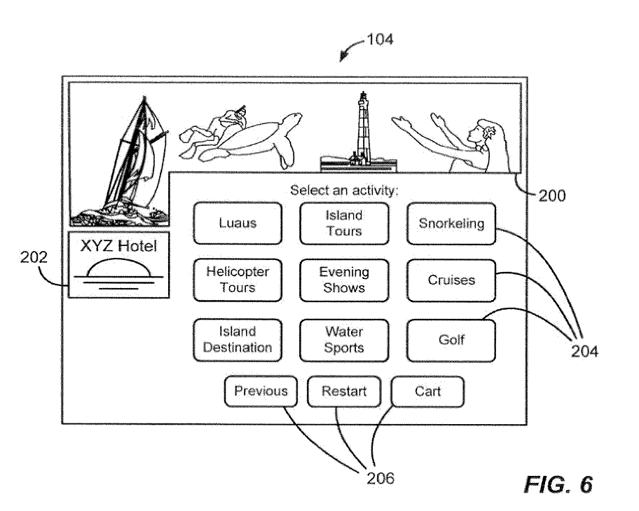

With particular reference to FIG. 6, an exemplar activity type page 104 is illustrated. Exemplar activity type page 104 includes a header image 200, a facility logo (e.g., XYZ Resort) associated with the particular facility 14, 16, and a plurality of selectable activity icons 204, each representing an activity category corresponding to one or more activities that are available for booking through the particular facility 14, 16. Control icons 206 can also be provided. Exemplar control icons 206 of FIG. 6 include a previous icon that enables the user to go back to the previous page, a restart icon that enables the user to restart the booking process, and a cart icon that enables a user to jump to view cart page 114. The user can select a particular activity category by clicking on an activity icon 204.

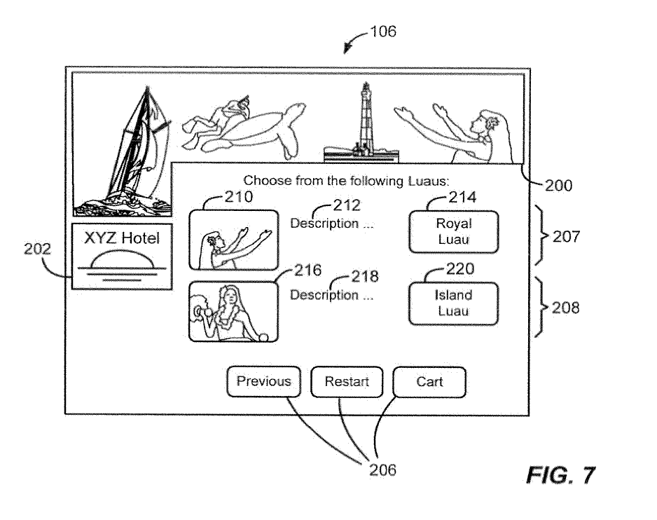

With particular reference to FIG. 7, an exemplar vendor selection page 106 is illustrated. Exemplar vendor selection page 106 presents a selection of vendors and their available activities associated with a particular activity category selected by the user. For example, exemplar vendor selection page 106 of FIG. 7 presumes that the user selected “Luaus” on exemplar activity type page 104 of FIG. 6, and presents exemplar Luaus 207, 208 that are available for booking through various vendors. Luau 207 is advertised as the “Royal Luau” and includes a picture 210, a description 212, and a selectable icon 214. Luau 208 is advertised as the “Island Luau” and includes a picture 216, a description 218, and a selectable icon 220. It is contemplated that additional advertisement information for the particular activities can be provided. By way of one non-limiting example, a trailer video for a particular activity can be provided to better promote that activity and/or vendor. The user selects the particular activity to book using selectable icon 214, 220.

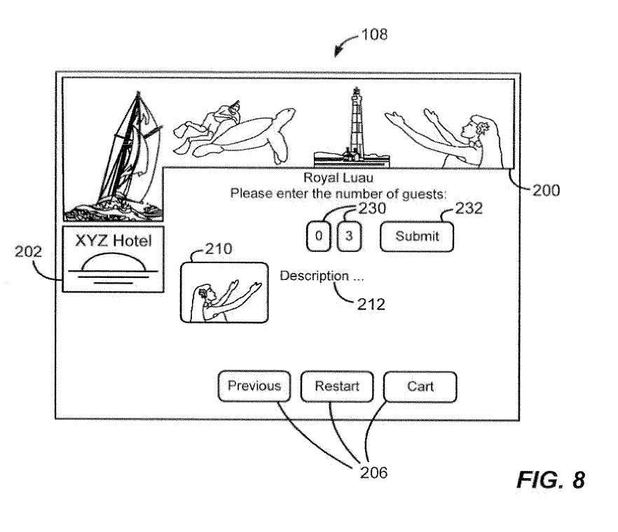

With particular reference to FIG. 8, an exemplar guest count page 108 is illustrated. Exemplar guest count page 108 of FIG. 8 presumes that the user selected the “Royal Luau” from exemplar vendor selection page of FIG. 7, and enables the user to indicate the number of guests that will participate in the selected activity. More specifically, exemplar guest count page 108 provides information regarding the selected activity (e.g., picture 210 and description 212), and provides guest count icons 230 and a submit icon 232. The user can indicate the number of guests using guest count icons 230 (e.g., 3 guests in the exemplar illustration), and can submit the number of guests by clicking on submit icon 232.

Upon submitting the desired number of guests for the particular activity, an availability call is generated by device 12, which is sent to voucher server system 22 via network 18. The availability call provides specific information to voucher server system 22, which includes, but is not limited to, the facility identification, the selected activity, the selected vendor, and the number of guests. In one embodiment, the facility identification can be provided as a URL associated with the particular facility 14, 16.

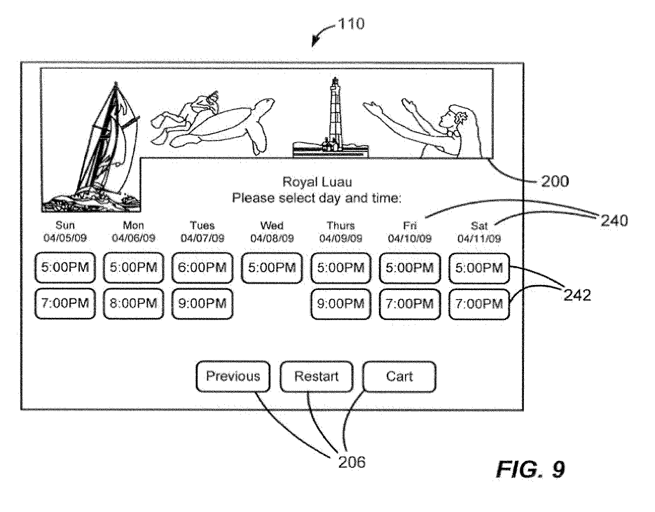

Voucher server system 22 accesses a database based on the facility identification, which database includes up-to-date information regarding the availability of activities available for booking through the particular facility 14, 16. Voucher server system 22 provides availability data based on the selected activity, the selected vendor, and the number of guests. With particular reference to FIG. 9, an activity availability page 110 is illustrated. Exemplar activity availability page 110 includes date information 240, and available time icons 242 corresponding to each date. Available time icons 242 indicate the times that are available for booking the particular activity based on the guest count information provided by the user. In the example of FIG. 8, the guest count includes three guests for the ‘Royal Luau.’ Consequently, the example if FIG. 9 indicates the dates and times that are available for three guests to book the ‘Royal Luau.’ By clicking on a particular available time icon 242, the user can select the data and time to book the particular activity. Once the user has selected the desired date and time, a price call, or request is sent to voucher server system 22, the price call indicating the selected date and time. In response, voucher server system 22 provides price information to device 12, which price information can include one or more price codes, described in further detail below.

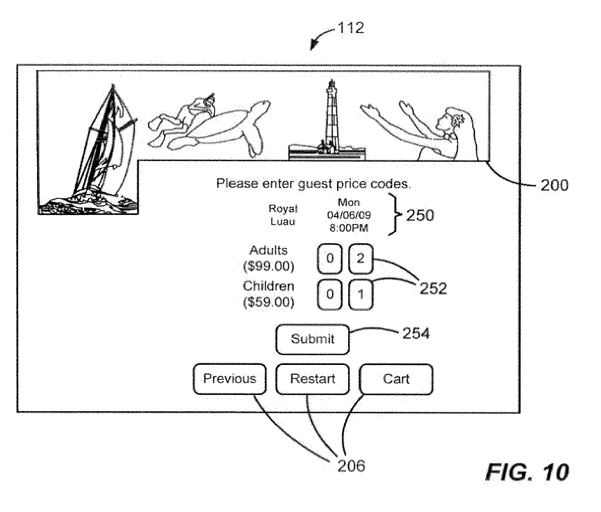

With particular reference to FIG. 10, an exemplar price code page 112 is illustrated. Price code page 112 of FIG. 10 presumes that the user had selected available time icon 242 corresponding to Monday, Apr. 6, 2009 at 8:00 PM on exemplar activity availability page 110 of FIG. 9. Price code page 112 includes activity information 250 (e.g., activity name, date and time), guest count icons 252 corresponding to particular price codes (e.g., ‘Adults’ and ‘Children’ in the exemplar illustration), and a submit icon 254. Although only adult and children price codes are illustrated, it is contemplated that additional price codes and corresponding guest count icons 252 can be included. Other exemplar price codes can include, but are not limited to a ‘Seniors’ price code, and a ‘Students’ price code. The user can indicate the number of guests per price code using the guest count icons. In some embodiments, the number of guest can be limited to the number indicated by the user on guest count page 108. In the instant example, three guests had been indicated using guest count page 108 of FIG. 8. Consequently, the guest count on price code page 112 of FIG. 10 can be limited to three guests. The user can submit the number of guests per price code by clicking on submit icon 254.

The guest price code information for each activity to be booked by the user is sent to voucher server system 22, which initiates a purchase and confirmation routine. More specifically, the user can view his/her shopping cart using via view cart page 114 to review the activities, booking times and guest count information that had been input. The user can initiate purchase of the activities and confirm the bookings from view cart page 114. More specifically, the user can initiate the purchase of the activities listed in his/her cart by issuing a purchase confirmation. Upon initiating the purchase, voucher server system 22 can request contact and billing information from the user via billing information page 116. Exemplar contact and billing information can include, but is not limited to, the user's full name, a contact telephone number, a credit card number and expiration date, and/or a billing address corresponding to the particular credit card.

In some embodiments, the contact and billing information can be automatically provided to voucher server system 22. More specifically, the contact and billing information can be provided to voucher server system 22 from the particular facility 14, 16 based on an identification associated with the user (e.g., based on the RoomID discussed above). For example, when checking into facility 14, 16, the user can provide contact and billing information, which information can be linked to a RoomID associated with the particular room the user is staying in. The RoomID can be provided to voucher server system 22 from the particular device 12 located in the user's room, which voucher server system 22 can use to access the user's contact and billing information.

Upon completing the purchase, voucher server system 22 sends a booking confirmation to the user, which booking confirmation can be presented to the user via confirmation page 118. Voucher server system 22 updates the availability of bookings for particular events in its database upon purchase by the user. Voucher server system 22 also sends voucher data to the facility to make a voucher available to the user. In some embodiments, the voucher data can be electronically provided to device 12 that is being used by the user, to enable the user to print a physical voucher. In some embodiments, voucher data can be electronically provided to a clerk and/or concierge of the particular facility 14, 16 where the user is staying. In this manner, the clerk and/or concierge can print the physical voucher to be delivered to, or retrieved by the user. In some embodiments, the voucher data can be electronically provided to the user. For example, the voucher data can be sent to an email address associated with the user. The user can then print a physical voucher by accessing his/her email on any computer, and/or device 12.

Additionally, or alternatively, the voucher can be provided in an electronic form. For example, the user can display the voucher data on a handheld device (e.g., personal digital assistant (PDA), and/or mobile phone), which handheld device functions as the physical voucher. For example, the voucher data can be provided as a text message to the user's handheld device, and/or as an email that is accessible using the handheld device. In other embodiments, the voucher data can be provided directly to the vendor that is offering the particular activity booked by the user. In such embodiments for example, the user can arrive at the vendor's location, and the vendor can authenticate the user's booking via the voucher data that the vendor had received.

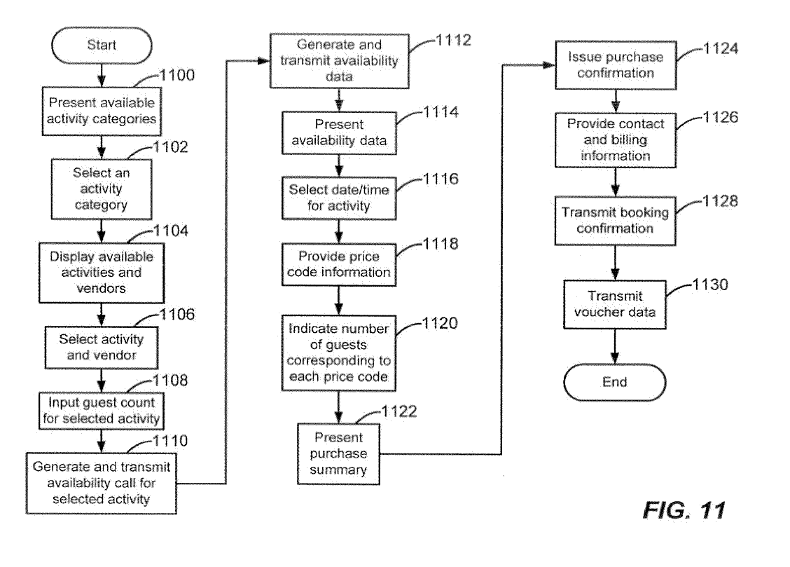

Referring now to FIG. 11, exemplar steps that can be executed in accordance with the present disclosure will be described in detail. In step 1100, a selection of available activity categories is presented to the user. As discussed above, the available activity categories are provided by catalog server system 20, and can be based on activities that are made available for booking by the particular facility 14, 16. In step 1102, the user selects a particular activity category. In step 1104, one or more activities and corresponding vendors associated with the selected activity category are displayed to the user. The user selects a particular activity and vendor in step 1106, and inputs a guest count for the particular activity in step 1108.

In step 1110, an availability call, or request, is generated and is transmitted to voucher server system 22 via network 18. Voucher server system 22 accesses its database based on the availability call, and transmits availability data to device 12 in step 1112. In step 1114, the availability data is presented to the user on device 12. In step 1116, the user selects a date and time to book the particular activity. Price code information is provided to the user in step 1118, which price code information includes one or more price codes for the selected activity. The user indicates the number of guests corresponding to one or more price codes in step 1120. In step 1122, the user is presented with a summary list of one or more selected activities, and corresponding guest counts, price codes, and price totals for booking. Such a summary list can be presented to the user via the view cart page 114.

In step 1124, the user initiates a purchase of the one or more selected activities by issuing a purchase confirmation that is transmitted to voucher server system 22. In step 1126, contact and billing information is provided to voucher server system 22, which charges the user for the one or more selected activities based on the guest count and the price codes. As discussed in detail above, contact and billing information can be input by the user, or the contact and billing information can automatically be transmitted to voucher server system 22. In step 1128, voucher server system 22 transmits a booking confirmation to device 12 for presentation to the user, which booking confirmation indicates that the selected one or more activities have been booked, and the user has been charged accordingly. Voucher server system 22 transmits voucher data in step 1130.

Embodiments of the present disclosure can be implemented in digital electronic circuitry, or in computer hardware, firmware, software, or in combinations thereof. The present disclosure can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Such a computer program can include modules and/or code segments for executing one or more of the features, aspects and/or implementations provided herein.

Method steps of the present disclosure can be performed by one or more programmable processors executing a computer program product to perform functions of the present disclosure by operating on input data and generating output. By way of one non-limiting example, a computer program product can include modules and/or code segments corresponding to each of the method steps, aspects and/or features provided herein. Method steps can also be performed by, and apparatus of the present disclosure can be implemented as, special purpose logic circuitry, e.g., an FPGA (field programmable gate array) or an ASIC (application-specific integrated circuit) and implemented on logic processors of a variety of types as those of skill will recognize.

Processors suitable for the execution of a computer program include, by way of example, both general and special purpose microprocessors, and any one or more processors of any kind of digital computer. Generally, a processor will receive instructions and data from a read-only memory or a random access memory or both. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The present disclosure can be implemented in a system including, but not limited to the exemplar systems described herein, which include a back-end component, e.g., as a data server, or that includes a middleware component, e.g., an application server, or that includes a front-end component, e.g., a client device having a graphical user interface or a Web browser through which a user can interact with an implementation of the invention, or any combination of such back-end, middleware, or front-end components. The components of the system can be interconnected by any form or medium of digital data communication, e.g., a communication network.

A number of embodiments of the invention have been described. Nevertheless, it will be understood that various modifications may be made without departing from the spirit and scope of the present disclosure. Accordingly, other embodiments are within the scope of the following claims.

What is claimed is:

1. A computer-implemented method of providing voucher data for a booked activity comprising:
receiving a first request at a server, the first request including a first facility identifier and having been generated using a first device that is located at a facility corresponding to the first facility identifier, which facility is remote from the server;
selecting a first set of data from a database based on the first facility identifier;
generating a first response based on the first set of data and the first request;
transmitting the first response to the first device;
receiving a first purchase confirmation at the server, the purchase confirmation being generated based on the first response received at the first device; and
providing first voucher data based on the first purchase confirmation.

2. The method of claim 1 wherein the first facility identifier includes a uniform resource locator (URL) associated with the facility.

3. The method of claim 1 further comprising:
transmitting price code information to the first device; and
receiving guest number information from the first device, the guest number information corresponding to the price code information, the first purchase confirmation being generated based on the guest number information and the price code information.

4. The method of claim 1 further comprising:
receiving a second request at the server, the second request having been generated using a second device and including the first facility identifier;
generating a second response based on the first set of data and the second request;
transmitting the second response to the second device;
receiving a second purchase confirmation at the server, the second purchase confirmation being generated based on the second response received at the second device; and
providing second voucher data based on the second purchase confirmation.

5. The method of claim 1 further comprising:
receiving a second request at the server, the second request having been generated using a second device and including a second facility identifier associated with a second facility, at which the second device is located;
selecting a second set of data from the database based on the second facility identifier, the second set of data being different than the first set of data;
generating a second response based on the second set of data and the second request;
transmitting the second response to the second device;
receiving a second purchase confirmation at the server, the second purchase confirmation being generated based on the second response received at the second device; and
providing second voucher data based on the second purchase confirmation.

6. The method of claim 1 further comprising:
providing a local database that is remotely located from the database;
presenting data from the local database at the first device, the first request being generated based on the data.

7. The method of claim 6 wherein the data from the local database corresponds to activities that are available for reservation through the first facility, and the first set of data from the database includes at least one of availability information and pricing information for the activities

8. The method of claim 1 wherein the first request includes information indicating an activity and a number of people to participate in the activity.

9. A computer-readable storage medium encoded with a computer program comprising instructions that, when executed, operate to cause one or more processors to perform operations comprising:
receiving a first request at a server, the first request including a first facility identifier and having been generated using a first device that is located at a facility corresponding to the first facility identifier, which facility is remote from the server;
selecting a first set of data from a database based on the first facility identifier;
generating a first response based on the first set of data and the first request;
transmitting the first response to the first device;
receiving a first purchase confirmation at the server, the purchase confirmation being generated based on the first response received at the first device; and
providing first voucher data based on the first purchase confirmation.

10. The computer-readable storage medium of claim 9 wherein the facility identifier includes a uniform resource locator (URL) associated with the facility.

11. The computer-readable storage medium of claim 9 wherein the operations further comprise:
transmitting price code information to the first device; and
receiving guest number information from the first device, the guest number information corresponding to the price code information, the first purchase confirmation being generated based on the guest number information and the price code information.

12. The computer-readable storage medium of claim 9 wherein the operations further comprise:
receiving a second request at the server, the second request having been generated using a second device and including the first facility identifier;
generating a second response based on the first set of data and the second request;
transmitting the second response to the second device;
receiving a second purchase confirmation at the server, the second purchase confirmation being generated based on the second response received at the second device; and
providing second voucher data based on the second purchase confirmation.

13. The computer-readable storage medium of claim 9 wherein the operations further comprise:
receiving a second request at the server, the second request having been generated using a second device and including a second facility identifier associated with a second facility, at which the second device is located;
selecting a second set of data from the database based on the second facility identifier, the second set of data being different than the first set of data;
generating a second response based on the second set of data and the second request;
transmitting the second response to the second device;
receiving a second purchase confirmation at the server, the second purchase confirmation being generated based on the second response received at the second device; and
providing second voucher data based on the second purchase confirmation.

14. The computer-readable storage medium of claim 9 wherein the operations further comprise:
providing a local database that is remotely located from the database;
presenting data from the local database at the first device, the first request being generated based on the data.

15. The computer-readable storage medium of claim 14 wherein the data from the local database corresponds to activities that are available for reservation through the first facility, and the first set of data from the database includes at least one of availability information and pricing information for the activities

16. The computer-readable storage medium of claim 9 wherein the first request includes information indicating an activity and a number of people to participate in the activity.

17. A system comprising:
one or more processors; and
a computer-readable storage medium coupled to the one or more processors having instructions stored thereon which, when executed by the one or more processors, causes the one or more processors to perform operations comprising:
receiving a first request at a server, the first request including a first facility identifier and having been generated using a first device that is located at a facility corresponding to the first facility identifier, which facility is remote from the server;
selecting a first set of data from a database based on the first facility identifier;
generating a first response based on the first set of data and the first request;
transmitting the first response to the first device;
receiving a first purchase confirmation at the server, the purchase confirmation being generated based on the first response received at the first device; and
providing first voucher data based on the first purchase confirmation.

18. The system of claim 17 wherein the operations further comprise:
transmitting price code information to the first device; and
receiving guest number information from the first device, the guest number information corresponding to the price code information, the first purchase confirmation being generated based on the guest number information and the price code information.

19. The system of claim 17 wherein the operations further comprise:
receiving a second request at the server, the second request having been generated using a second device and including the first facility identifier;
generating a second response based on the first set of data and the second request;
transmitting the second response to the second device;
receiving a second purchase confirmation at the server, the second purchase confirmation being generated based on the second response received at the second device; and
providing second voucher data based on the second purchase confirmation.

20. The system of claim 17 wherein the operations further comprise:
receiving a second request at the server, the second request having been generated using a second device and including a second facility identifier associated with a second facility, at which the second device is located;
selecting a second set of data from the database based on the second facility identifier, the second set of data being different than the first set of data;
generating a second response based on the second set of data and the second request;
transmitting the second response to the second device;
receiving a second purchase confirmation at the server, the second purchase confirmation being generated based on the second response received at the second device; and
providing second voucher data based on the second purchase confirmation.
